(19) United States
(12) Patent Application Publication
(10) Pub. No.: US 2024/0058816 A1
(43) Pub. Date: Feb. 22, 2024

(54) DEVICES AND METHODS FOR SAMPLE PARTITIONING

(71) Applicant: COMBINATI INCORPORATED, Carlsbad, CA (US)

(72) Inventor: Ju-Sung HUNG, Carlsbad, CA (US)

(21) Appl. No.: 18/269,893

(22) PCT Filed: Dec. 28, 2021
(86) PCT No.: PCT/US2021/065397

§ 371 Date: Jun. 27, 2023

Related U.S. Application Data
(60) Provisional application No. 63/131,513, filed on Dec. 29, 2020.

(51) Int. Cl. B01L 3/00

(52) U.S. Cl. CPC B01L 3/502715; B01L 2200/0689; B01L 2300/041; B01L 2300/0861

(57) ABSTRACT

The present disclosure provides devices and methods for partitioning samples and analyzing analytes. The device may comprise one or more of a first plurality of first chambers and a second plurality of second chambers. A first chamber of the first plurality of chambers may have a first volume that is different from a second volume of a second chamber of the second plurality of chambers. The first plurality of chambers may comprise at least about 100 first chambers and the second plurality of chambers may comprise at least about 100 second chambers.

### CROSS-REFERENCE

This application claims the benefit of PCT/US2021/065397 filed Dec. 28, 2021 and U.S. Provisional Patent Application No. 63/131,513, filed Dec. 29, 2020, the contents of which are hereby incorporated by reference in their entirety.

### BACKGROUND

Microfluidic devices are devices that contain structures that handle fluids on a small scale, such as microliters, nanoliters, or smaller quantities of fluids. One application of microfluidic structures is in digital polymerase chain reaction (dPCR). For example, a microfluidic structure with multiple partitions may be used to partition a nucleic acid sample for dPCR. For genomic researchers and clinicians, dPCR is particularly powerful in rare mutation detection, quantifying copy number variants, and Next Gen Sequencing library quantification. The potential use in clinical settings for liquid biopsy with cell free DNA and viral load quantification further increases the value of dPCR technology.

### SUMMARY

Provided herein are methods and devices that may be useful for partitioning and analysis of a sample (i.e. a biological sample), for example, amplifying and quantifying nucleic acids. The present disclosure provides methods, systems, and devices that may enable sample preparation, sample amplification, and sample analysis. Sample analysis may be performed through the use of digital polymerase chain reaction (dPCR). Samples may be partitioned into chambers of differing sizes and volumes as to assist with analyte detection and assay dynamic range. This may enable sample analysis, for example nucleic acid amplification and quantification, at a reduced cost and complexity as compared to other systems and methods.

In an aspect, the present disclosure provides a device for partitioning a sample, comprising: a first plurality of chambers and a second plurality of chambers, wherein (i) the first plurality of chambers comprises at least about 100 first chambers; (ii) the second plurality of chambers comprises at least about 100 second chambers; and (iii) a first chamber of the at least about 100 first chambers has a first volume different from a second volume of a second chamber of the at least about 100 second chambers.

In some embodiments, the first volume is at least twice as large as the second volume. In some embodiments, the first volume is at least five times as large as the second volume. In some embodiments, the device does not include any moving parts. In some embodiments, the device further comprises a channel in fluid communication with the first plurality of chambers and the second plurality of chambers. In some embodiments, the device further comprises a cover configured to seal the first plurality of chambers, the second plurality of chambers, and the channel. In some embodiments, the device further comprises a body comprising the channel, the first plurality of chambers, and the second plurality of chambers, and wherein the cover is fixed to the body.

In some embodiments, the second plurality of chambers is in fluid communication with the channel upstream of the first plurality of chambers. In some embodiments, the channel comprises at least two branches, and wherein the first plurality of chambers is disposed along a first branch of the at least two branches and the second plurality of chambers is disposed along a second branch of the at least two branches.

In some embodiments, the first plurality of chambers comprises at least about 1,000 first chambers and the second plurality of chamber comprises at least about 1,000 second chambers. In some embodiments, the first plurality of chambers comprises at least about 5,000 first chambers and the second plurality of chamber comprises at least about 5,000 second chambers. In some embodiments, a total volume of the first plurality of chambers is less than about 10 microliters (μL). In some embodiments, a total first volume of the first plurality of chambers is greater than or equal to about 10 μL. In some embodiments, a total second volume of the second plurality of chambers is less than about 1 μL. In some embodiments, a total volume of the second plurality of chambers is greater than or equal to about 1 μL. In some embodiments, a total first volume of the first plurality of chambers is at least five times as large as a total second volume of the second plurality of chambers. In some embodiments, the total first volume is at least ten times as large as the total second volume.

In some embodiments, the first chambers of the first plurality of chambers comprise substantially similar volumes. In some embodiments, the second chambers of the second plurality of chambers comprise substantially similar volumes. In some embodiments, the first volume is greater than or equal to about 100 picoliters (pL). In some embodiments, wherein the first volume is less than or equal to about 1000 pL. In some embodiments, the second volume is less than or equal to about 250 pL. In some embodiments, the second volume is greater than or equal to about 25 pL.

In some embodiments, a first depth of the first chamber is substantially similar to a second depth of the second chamber. In some embodiments, a first cross-sectional area of the first chamber is substantially different than a second cross-sectional area of the second chamber. In some embodiments the device is a microfluidic device.

In an aspect, the present disclosure provides a method of analyzing an analyte, comprising providing a fluidic device comprising a plurality of first chambers and a plurality of second chambers, wherein; the first plurality of chambers comprises at least about 100 first chambers; the second plurality of chambers comprises at least about 100 second chambers; and a first chamber of the at least about 100 first chambers has a first volume different from a second volume of a second chamber of the at least about 100 second chambers, directing a fluidic sample comprising the analyte to the first chamber and the second chamber; and detecting the analyte in the first chamber and the second chamber.

In some embodiments, the first volume provides a first lower limit of detection of the analyte in the first chamber that is lower than a second lower limit of detection of the analyte in the second chamber provided by the second volume. In some embodiments, the first volume provides a first upper limit of detection of the analyte in the first chamber that is lower than a second upper limit of detection of the analyte in the second chamber provided by the second volume of the second chamber. In some embodiments, the method further comprises detecting the analyte at a concentration at or above the first lower limit of detection and below the second lower limit of detection. In some embodiments, the method further comprises detecting the analyte at a concentration above the first upper detection limit and below the second upper detection limit. In some embodiments, the first volume provides a first working range of detection of the analyte in the first chamber that is different than a second working range of detection of the analyte in the second chamber provided by the second volume. In some embodiments, the first volume permits analysis of a first analyte concentration and the second volume permits analysis of a second analyte concentration, and wherein the first analyte concentration and the second analyte concentration are different.

In some embodiments, the first volume is at least twice as large as the second volume. In some embodiments, the first volume is at least five times as large as the second volume. In some embodiments, the fluidic device does not include any moving parts.

In some embodiments, the fluidic device further comprises a channel in fluid communication with the first plurality of chambers and the second plurality of chambers, and wherein, in (b), the fluidic sample is directed from the channel to the first chamber and the second chamber. In some embodiments, the method further comprises a cover configured to seal the first plurality of chambers, the second plurality of chambers, and the channel. In some embodiments, the fluidic device comprises a body comprising the channel, the first plurality of chambers, and the second plurality of chambers, and wherein the cover is fixed to the body. In some embodiments, the second plurality of chambers are in fluid communication with the channel upstream of the first plurality of chambers. In some embodiments, the channel comprises at least two branches, and wherein the first plurality of chambers is disposed along a first branch of the at least two branches and the second plurality of chambers is disposed along a second branch of the at least two branches.

In some embodiments, the first plurality of chambers comprises at least about 1,000 first chambers and the second plurality of chamber comprises at least about 1,000 second chambers. In some embodiments, the first plurality of chambers comprises at least about 5,000 first chambers and the second plurality of chamber comprises at least about 5,000 second chambers. In some embodiments, a total volume of the first plurality of chambers is less than about 10 microliters (μL). In some embodiments, a total volume of the first plurality of chambers is greater than or equal to about 10 μL. In some embodiments, a total volume of the second plurality of chambers is less than about 1 μL. In some embodiments, a total volume of the second plurality of chambers is greater than or equal to about 1 μL. In some embodiments, a total first volume of the first plurality of chambers is at least five times as large as a total second volume of the second plurality of chambers. In some embodiments, the total first volume is at least ten times as large as the total second volume.

In some embodiments, first chambers of the first plurality of chambers comprise substantially similar volumes. In some embodiments, second chambers of the second plurality of chambers comprise substantially similar volumes. In some embodiments, the first volume is greater than or equal to about 100 picoliters (pL). In some embodiments, the first volume is less than or equal to about 1000 pL. In some embodiments, the second volume is less than or equal to about 250 pL. In some embodiments, the second volume is greater than or equal to about 25 pL.

In some embodiments, a depth of the first chamber is substantially similar to a depth of the second chamber. In some embodiments, a cross-sectional area of the first chamber is substantially different than a cross-sectional area of the second chamber.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede, take precedence, or both, over any such contradictory material.

### BRIEF DESCRIPTION OF THE DRAWINGS

The novel features of the devices and methods are set forth with particularity in the appended claims. A better understanding of the features and advantages of the present devices and methods will be obtained by reference to the following detailed description that sets forth illustrative embodiments, in which the principles of the devices and methods are utilized, and the accompanying drawings (also “figure” and “FIG.” herein), of which:

FIG. 1A schematically illustrates a top view of an example microfluidic device with two sets of partition microchambers, one set having a larger fluid volume and another set having a smaller fluid volume.

FIG. 1B schematically illustrates a cross-sectional view of the example microfluidic device.

FIG. 2 schematically illustrates an example method for analyzing an analyte of a sample.

FIG. 3 shows a computer system that is programmed or otherwise configured to implement methods provided herein.

### DETAILED DESCRIPTION

While various embodiments of the devices and methods have been shown and described herein, it will be obvious to those skilled in the art that such embodiments are provided by way of example only. Numerous variations, changes, and substitutions may occur to those skilled in the art without departing from the devices and methods. It will be understood that various alternatives to the embodiments of the devices and methods described herein may be employed.

The term “sample,” as used herein, generally refers to any sample containing or suspected of containing a nucleic acid molecule. For example, a sample can be a biological sample containing one or more nucleic acid molecules. The biological sample can be obtained (e.g., extracted or isolated) from or include blood (e.g., whole blood), plasma, serum, urine, saliva, mucosal excretions, sputum, stool and tears. The biological sample can be a fluid or tissue sample (e.g., skin sample). In some examples, the sample is obtained from a cell-free bodily fluid, such as whole blood. In such instance, the sample may include cell-free DNA or cell-free RNA. In some examples, the sample can include circulating tumor cells. In some examples, the sample is an environmental sample (e.g., soil, waste, ambient air and etc.), industrial sample (e.g., samples from any industrial processes), and food samples (e.g., dairy products, vegetable products, and meat products). The sample may be processed prior to loading into the microfluidic device. For example, the sample may be processed to lyse cells, purify the nucleic acid molecules, or to include reagents.

As used herein, the term “fluid,” generally refers to a liquid or a gas. A fluid cannot maintain a defined shape and will flow during an observable time frame to fill the container into which it is put. Thus, the fluid may have any suitable viscosity that permits flow. If two or more fluids are present, each fluid may be independently selected among any fluids (e.g., liquids, gases, and the like).

As used herein, the term “partition,” generally refers to a division into or distribution into portions or shares. For example, a partitioned sample is a sample that is isolated from other samples. Examples of structures that enable sample partitioning include wells and chambers.

As used herein, the term “digitized” or “digitization” may be used interchangeable and generally refers to a sample that has been distributed into one or more partitions. A digitized sample may or may not be in fluid communication with another digitized sample. A digitized sample may not interact or exchange materials (e.g., reagents, analytes, etc.) with another digitized sample.

As used herein, the term “microfluidic,” generally refers to a chip, area, device, article, or system that may include one or more of at least one channel, a plurality of siphon apertures, and an array of chambers. The channel may have a cross-sectional dimension less than or equal to about 10 millimeters (mm), less than or equal to about 5 mm, less than or equal to about 4 mm, less than or equal to about 3 mm, less than or equal to about 2 mm, less than or equal to about 1.5 mm, less than or equal to about 1 mm, less than or equal to about 750 micrometers (μm), less than or equal to about 500 μm, less than or equal to about 250 μm, less than or equal to about 100 μm, or less.

As used herein, the term “depth,” generally refers to the distance measured from the bottom of the channel, siphon aperture, or chamber to the thin film that caps the channel, plurality of siphon apertures, and array of chambers.

As used herein, the terms “cross-section” or “cross-sectional” may be used interchangeably and generally refer to a dimension or area of a channel or siphon aperture that is substantially perpendicularly to the long dimension of the feature.

As used herein, the terms “pressurized off-gassing” or “pressurized degassing” may be used interchangeably and generally refer to removal or evacuation of a gas (e.g., air, nitrogen, oxygen, etc.) from a channel or chamber of the device (e.g., microfluidic device) to an environment external to the channel or chamber through the application of a pressure differential. The pressure differential may be applied between the channel or chamber and the environment external to the channel or chamber. The pressure differential may be provided by the application of a pressure source to one or more inlets to the device or application of a vacuum source to one or more surfaces of the device. Pressurized off-gassing or pressurized degassing may be permitted through a film or membrane covering one or more sides of the channel or chamber.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

### Microfluidic Devices for Partitioning Samples

The present disclosure provides devices for partitioning a sample, analyzing analytes, or both. A device of the present disclosure may be formed from a polymeric material (e.g., thermoplastic), and may include one or more of a first plurality of first chambers and a second plurality of second chambers, wherein a first chamber of the first plurality of chambers may have a first volume that is different from a second volume of a second chamber of the second plurality of chambers. The microfluidic device may be a chip or cartridge. A microfluidic device of the present disclosure may be a single-use or disposable device. As an alternative, the microfluidic device may be multi-use device. The use of polymers (e.g., thermoplastics) to form the microfluidic structure may allow for the use of an inexpensive and highly scalable injection molding processes, while the first and second plurality of chambers may provide an improved ability to partition samples, analyze analytes, or both, avoiding dynamic range detection limits that may be present in some microfluidic structures that do not incorporate such plurality of chambers and different volumes.

For example, as similar devices or a microfluidic device operates on a sub-millimeter scale and handles micro-liters, nano-liters, or smaller quantities of fluids, a major obstacle in processing samples or analyzing analytes may be the ability to simultaneously detect high concentration and low concentration analytes. For example, high concentration analytes may over-saturate chambers resulting in a signal that falls outside the maximum detection limit or dynamic range of a detector. Similarly, low concentration analytes may be of a concentration below the limit of quantification outside the dynamic range of an instrument. In order to avoid sample concentrations falling outside the dynamic range of detection, other microfluidic systems use multiple sample or analyte runs or multiple chips or cartridges per sample, which may increase difficulty of analysis and expense, particularly at scale.

In an aspect, the present disclosure provides a device (e.g., microfluidic device) for partitioning a sample. The device may include a first plurality of chambers and a second plurality of chambers. A first chamber of the first plurality of chambers may have a first volume. A second chamber of the second plurality of chambers may have a second volume. The volume of the first chamber may be different than the volume of the second chamber.

The device may include at least 1, 2, 3, 4, 5, 6, 8, 10, 12, or more plurality of chambers. Each plurality of chambers may include chambers of a same volume. For example, the chambers of a first plurality of chambers may have substantially the same first volume and the chambers of a second plurality of chambers may have substantially the same second volume. The first volume and the second volume may be different. The different plurality of chambers may comprise the same number of chambers (e.g., a first plurality of chambers may have the same or substantially the same number of chambers as a second or third plurality of chambers). Alternatively, or in addition to, the number of chambers in a plurality of chambers may vary across the device (e.g., a first plurality of chambers may have a different number of chambers than a second or third plurality of chambers.

The first plurality of chambers may comprise at least about 10 first chambers, at least about 20 first chambers, at least about 50 first chambers, at least about 100 first chambers, at least about 150 first chambers, at least about 200 first chambers, at least about 500 first chambers, at least about 1,000 first chambers, at least about 5,000 first chambers, at least about 10,000 first chambers, at least about 50,000 first chambers, or at least about 100,000 first chambers. A first chamber or the first chambers may be configured to receive or may receive a solution including a sample containing an analyte. In an example, the first plurality of chambers comprises at least 100 chambers. In another example, the first plurality of chambers comprises at least 500 chambers. In another example, the first plurality of chambers comprises at least 1,000 chambers. In another example, the first plurality of chambers comprises at least 5,000 chambers. The first chamber or the first chambers may be configured to receive and retain or may receive and retain at least a portion of a solution from a channel during partitioning. The first chamber or the first chambers may be configured to have a first volume. The device may include a second plurality of chambers. The second plurality of chambers may comprise at least about 10 second chambers, at least about 20 second chambers, at least about 50 second chambers, at least about 100 second chambers, at least about 150 second chambers, at least about 200 second chambers, at least about 500 second chambers, at least about 1,000 second chambers, at least about 5,000 first chambers, at least about 10,000 second chambers, at least about 50,000 second chambers, or at least about 100,000 second chambers. In an example, the second plurality of chambers comprises at least 100 chambers. In another example, the second plurality of chambers comprises at least 500 chambers. In another example, the second plurality of chambers comprises at least 1,000 chambers. In another example, the second plurality of chambers comprises at least 5,000 chambers. A second chamber or the second chambers may be configured to receive or may receive a solution including a sample containing an analyte. The second chamber or the second chambers may be configured to receive and retain or may receive and retain at least a portion of a solution from a channel during partitioning. The second chamber or the second chambers may be configured to have a second volume. In an example, the device includes a first plurality of chambers comprising at least 100 first chambers and a second plurality of chambers comprising at least 100 second chambers. In an example, the device includes a first plurality of chambers comprising at least 1000 first chambers and a second plurality of chambers comprising at least 1000 second chambers. In an example, the device includes a first plurality of chambers comprising at least 5000 first chambers and a second plurality of chambers comprising at least 5000 second chambers.

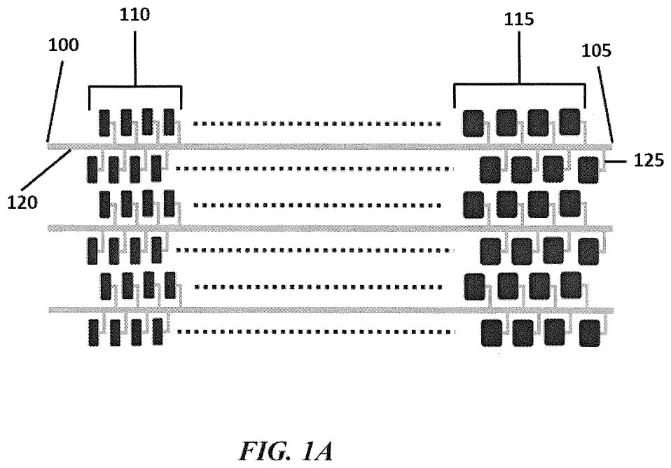

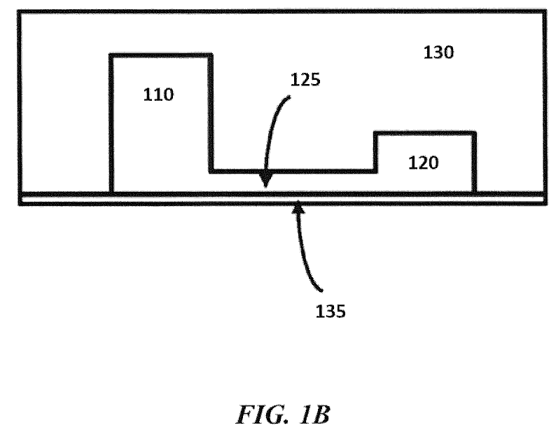

An example device, or microfluidic device, is shown in FIGS. 1A and 1B. FIG. 1A shows an example top view of the example device. The device may include one or more fluid flow channels, or channels, 120. The fluid flow channel 120 may include at least two ends. One end 100 of the fluid flow channel 120 may be in fluid communication with or coupled to an inlet port. The inlet port may provide sample to the fluid flow channel 120. The second end 105 of the fluid flow channel may be a dead end or an end otherwise not coupled to an inlet or outlet. The device may include one or more sets or pluralities of chambers 110 and 115. Some sets or pluralities of chambers may contain smaller fluid or partition volumes per chamber or in sum or both e.g. 110 than the fluid or partition volumes per chamber or sum or both of another plurality or sets of chambers e.g. 115. The fluid flow path 120, which may be a channel, may be in fluid communication with one or more chambers 110 and 115 and thus the chambers of different pluralities of chambers 110 and 115 may be in fluid communication with each other. In an example, the fluid flow path 120 is in fluid communication with a plurality of chambers 110 and 115. Fluid communication between the fluid flow path 120 and the chambers 110 and 115 may be provided by one or more siphon apertures 125. The chambers 110 and 115 may be disposed adjacent to one or more outgas channels. The device may include more than one fluid flow channel 120. The fluid flow channels 120 may or may not be in fluid communication with one another. Each fluid flow channel 120 may be in fluid communication with a set of chambers 110 and 115. FIG. 1B shows an example top view of the example device. The device may include body or device body 130. The device body 130 may comprise a thermoplastic or other plastic. The device body 130 may be formed by a molding process. The device body 130 may include one or more of channels 120, chamber 110, siphon aperture 125, or any combination thereof. The microfluidic device may further include a cover 135 adhered to the body 130 to seal one or more of the fluid flow channel 120, chamber 110, siphon aperture 125, or any combination thereof.

A first chamber of the first plurality of chambers may have a first volume different from a second volume of the second chamber of the second plurality of chambers. The volume of the first chamber may be at least twice as large, at least five times as large, at least ten times as large, at least thirty times as large, or at least one hundred times as large as the second volume. The total first volume of the first plurality of chambers may be less than about 0.1 microliters (μL), less than about 1 μL, less than about 10 μL, greater than or equal to about 10 μL, greater than 100 μL, or greater than 1000 μL. The total second volume of the second plurality of chambers may be less than about 0.1 microliters (μL), less than about 1 μL, less than about 10 μL, greater than or equal to about 10 μL, greater than 100 μL, or greater than 1000 μL. The total first volume of the first plurality of chambers may be at least twice, at least three times, at least four times, at least five times, at least ten times, at least thirty times, or at least one hundred times as large as a total second volume of the second plurality of chambers. The first chambers of the first plurality of chambers may comprise substantially similar volumes. The second chambers of the second plurality of chambers may comprise substantially similar volumes. The first volume of a first chamber may be greater than or equal to about 1 picoliters (pL), 10 pL, 25 pL, 100 pL, 250 pL, 1,000 pL, 3,000 pL, or 10,000 pL. The first chamber may comprise a first depth. The second chamber or subsequent chambers may comprise a second depth. The first depth may be larger, substantially similar, or smaller than the second depth. The first chamber may comprise a first cross-sectional area. The second chamber may comprise a second cross-sectional area. The first cross-sectional are may be smaller, substantially similar, or larger than the second cross-sectional area.

The first plurality of chambers, the second plurality of chambers, or both, may comprise an array of chambers. The device may include a single array of chambers or multiple arrays of chambers, with each array of chambers fluidically isolated from the other arrays. The array of chambers may be arranged in a row, in a grid configuration, in an alternating pattern, or in any other configuration. The device may have at least 1, 2, 3, 4, 5, 10, 15, 20, 30, 40, 50, or more arrays of chambers. The arrays of chambers may be identical, or the arrays of chambers may be different (e.g., have a different number or configuration of chambers). The arrays of chambers may all have the same external dimension (e.g., the length and width of the array of chambers that encompasses all features of the array of chambers) or the arrays of chambers may have different external dimensions. An array of chambers may have a width of less than or equal to about 100 mm, 75 mm, 50 mm, 40 mm, 30 mm, 20 mm, 10 mm, 8 mm, 6 mm, 4 mm, 2 mm, 1 mm, or less. The array of chambers may have a length of greater than or equal to about 50 mm, 40 mm, 30 mm, 20 mm, 10 mm, 8 mm, 6 mm, 4 mm, 2 mm, 1 mm, or less. In an example, the width of an array may be from about 1 mm to 100 mm or from about 10 mm to 50 mm. In an example, the length of an array may be from about 1 mm to 50 mm or from about 5 mm to 20 mm.

The array of chambers may have greater than or equal to about 1,000 chambers, 5,000 chambers, 10,000 chambers, 20,000 chambers, 30,000 chambers, 40,000 chambers, 50,000 chambers, 100,000 chambers, or more. In an example, the microfluidic device may have from about 10,000 to 30,000 chambers. In another example, the microfluidic device may have from about 15,000 to 25,000 chambers. The chambers may be cylindrical in shape, hemispherical in shape, or a combination of cylindrical and hemispherical in shape. Alternatively, or in addition to, the chambers may be cubic in shape. The chambers may have a cross-sectional dimension of less than or equal to about 500 μm, 250 μm, 100 μm, 80 μm, 60 μm, 30 μm, 15 μm, or less. In an example, the chamber has a cross-sectional dimension (e.g., diameter or side length) that is less than or equal to about 250 μm. In another example, the chamber has a cross-sectional dimension (e.g., diameter or side length) that is less than or equal to about 100 μm. In another example, the chamber has a cross-sectional dimension (e.g., diameter or side length) that is less than or equal to about 50 μm.

The depth of the chambers may be less than or equal to about 500 μm, 250 μm, 100 μm, 80 μm, 60 μm, 30 μm, 15 μm, or less. In an example, the chambers may have a cross-sectional dimension of about 30 μm and a depth of about 100 μm. In another example, the chambers may have a cross-sectional dimension of about 35 μm and a depth of about 80 μm. In another example, the chambers may have a cross-sectional dimension of about 40 μm and a depth of about 70 μm. In another example, the chambers may have a cross-sectional dimension of about 50 μm and a depth of about 60 μm. In another example, the chambers may have a cross-sectional dimension of about 60 μm and a depth of about 40 μm. In another example, the chambers may have a cross-sectional dimension of about 80 μm and a depth of about 35 μm. In another example, the chambers may have a cross-sectional dimension of about 100 μm and a depth of about 30 μm. In another example, the chambers and the channel have the same depth. In an alternative embodiment, the chambers and the channel have different depths.

The chambers may have any volume. The chambers may have the same volume, or the volume may vary across the microfluidic device. The chambers may have a volume of less than or equal to about 1000 picoliters (pL), 900 pL, 800 pL, 700 pL, 600 pL, 500 pL, 400 pL, 300 pL, 200 pL, 100 pL, 75 pL, 50 pL, 25 pL, or less picoliters. The chambers may have a volume from about 25 pL to 50 pL, 25 pL to 75 pL, 25 pL to 100 pL, 25 pL to 200 pL, 25 pL to 300 pL, 25 pL to 400 pL, 25 pL to 500 pL, 25 pL to 600 pL, 25 pL to 700 pL, 25 pL to 800 pL, 25 pL to 900 pL, or 25 pL to 1000 pL. In an example, the chamber(s) have a volume of less than or equal to 250 pL. In another example, the chambers have a volume of less than or equal to about 150 pL.

The volume of channel may be less than, equal to, or greater than the total volume of the chambers. In an example, the volume of the channel is less than the total volume of the chambers. The volume of the channel may be less than or equal to 95%, 90%, 80%, 70%, 60%, 50%, 40%, 30%, 20%, 10%, or less than the total volume of the chambers.

The device may further include a siphon aperture disposed between the channel and the chamber. The siphon aperture may be one of a plurality of siphon apertures connecting the channel to a plurality of chambers. The siphon aperture may be configured to provide fluid communication between the channel and the chamber. The lengths of the siphon apertures may be constant or may vary across the device (e.g., microfluidic device). The siphon apertures may have a long dimension that is less than or equal to about 150 μm, 100 μm, 50 μm, 25 μm, 10 μm, 5 μm, or less. The depth of the siphon aperture may be less than or equal to about 50 μm, 25 μm, 10 μm, 5 μm, or less. The siphon apertures may have a cross-sectional dimension of less than or equal to about 50 μm, 40 μm, 30 μm, 20 μm, 10 μm, 5 μm, or less.

The cross-sectional shape of the siphon aperture may be any suitable cross-sectional shape including, but not limited to, circular, oval, triangular, square, or rectangular. The cross-sectional area of the siphon aperture may be constant along the length of the siphon aperture. Alternatively, or in addition to, the cross-sectional area of the siphon aperture may vary along the length of the siphon aperture. The cross-sectional area of the siphon aperture may be greater at the connection to the channel than the cross-sectional area of the siphon aperture at the connection to the chamber. Alternatively, the cross-sectional area of the siphon aperture at the connection to the chamber may be greater than the cross-sectional area of the siphon aperture at the connection to the channel. The cross-sectional area of the siphon aperture may vary from about 50% to 150%, 60% to 125%, 70% to 120%, 80% to 115%, 90% to 110%, 95% to 100%, or 98% to 102%. The cross-sectional area of the siphon aperture may be less than or equal to about 2,500 μm², 1,000 μm², 750 μm², 500 μm², 250 μm², 100 μm², 75 m², 50 m₂, 25 μm², or less. The cross-sectional area of the siphon aperture at the connection to the channel may be less than or equal to the cross-sectional area of the channel. The cross-sectional area of the siphon aperture at the connection to the channel may be less than or equal to about 98%, 95%, 90%, 85%, 80%, 75%, 70%, 60%, 50%, 40%, 30%, 20%, 10%, 5%, 1%, 0.5%, or less of the cross-sectional area of the channel. The siphon apertures may be substantially perpendicular to the channel. Alternatively, or in addition to, the siphon apertures are not substantially perpendicular to the channel. An angle between the siphon apertures and the channel may be at least about 5°, 10°, 15°, 20°, 30°, 40°, 50°, 60°, 70°, or 90°.

The device may not, in some embodiments, include any moving parts. In other aspects, the device includes moving or mechanical parts such as valves, pumps, gates, switches, doors, or wheels. The device with mechanical parts may be used to provide or cut-off fluid communication between the plurality of first chambers, the plurality of second chambers, the channel or channels, inlets, outlets, or siphon apertures. In some aspects, these mechanical parts are controlled by a computer, a pressure, a mechanical switch, or temperature.

The device may further comprise a channel in fluid communication with the first plurality of chambers and the second plurality of chambers. The channel may be part of a fluid flow path. The fluid flow path may include the channel, one or more inlet ports, one or more outlet ports, or any combination thereof. In an example, the fluid flow path may not include an outlet port. The inlet port, outlet port, or both may be in fluid communication with the channel. The inlet port may be configured to direct a solution comprising the sample or analyte to the channel. The first chambers and the second chambers may be in fluid communication with the channel. The second plurality of chambers may be in fluid communication with the channel upstream of the first plurality of chambers. The second plurality of chambers may be in fluid communication with the channel downstream of the first plurality of chambers. The channel may comprise two, three, four, five, or more branches. The channel may comprise at least two branches. The first plurality of chambers may be disposed along a first branch of the at least two branches and the second plurality of chambers may be disposed along the second branch of the at least two branches. The channel may comprise at least four branches. The first plurality of chambers may be disposed along a first and second branch of the at least four branches and the second plurality of chambers may be disposed along the third and fourth branch of the at least four branches. The device may comprise a channel with any number of branches wherein the first and second plurality of chambers are disposed any number or combinations of branches wherein the first and second plurality of chambers are disposed on different branches.

The device path may include at least 1, 2, 3, 4, 5, 6, 8, 10, 12, 15, 20, 25, 30, 40, 50 or more channels. Each channel may be fluidically isolated from one another. Alternatively, or in addition to, the multiple channels may be in fluidic communication with one another. The channel may include a first end and a second end. The first end and second end may be connected to a single inlet port. Alternatively, or in addition to, the first end of the channel may be connected to an inlet port and the second end of the channel may be a dead end. A channel with a first end and second end connected to a single inlet port may be in a circular or looped configuration such that the fluid entering the channel through the inlet port may be directed through the first end and second end of the channel simultaneously. Alternatively, the first end may be connected to an inlet port and the second end may be connected to an outlet port. The fluid flow path or the chamber may not include valves to stop or hinder fluid flow or to isolate the chamber(s).

In some embodiments, the device further comprises a cover configured to seal the first plurality of chambers, the second plurality of chambers, the channel, or a combination thereof. In an example the cover may be a film which may include a metallic layer, a thermoplastic layer, or a polymer layer. The polymer or thermoplastic layer may be comprised of high density polyethylene (HDPE), polypropylene (PP), polyethylene terephthalate (PT), polycarbonate (PC), or cyclic olefin copolymer (COC). The metal layer may be comprised of aluminum, titanium, stainless steel, or nickel. In some embodiments, the metallic layer comprises aluminum. In some embodiments, a thickness of the metallic layer is less than or equal to about 50 nanometers (nm). In some embodiments, a thickness of the film is less than or equal to about 100 μm. In some embodiments, the thickness is from about 50 μm to 100 μm. In an example, the metallic layer is disposed on an external surface of the film. In another example, the metallic layer is configured to reduce surface contamination of the film. In another example, the film is substantially optically clear. The device may also comprise a body comprising the channel, the first plurality of chambers, the second plurality of chambers, the siphon aperture, or combinations thereof, and wherein the cover is fixedly secured to the body. The device body may comprise a thermoplastic, polymer, or other plastic. The thermoplastic or polymer may be high density polyethylene (HDPE), polypropylene (PP), polyethylene terephthalate (PT), polycarbonate (PC), or cyclic olefin copolymer (COC). The device body may be formed by a molding process, embossing process, or lithographic process.

The device (e.g., microfluidic device) may include a unit, which comprises the first plurality of chambers, the second plurality chambers, a channel or channels, or any combination thereof. The device may include at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, or more units. In an embodiment, the device has 4 units. The individual units may or may not be in fluid communication with one another. In an example, the individual units are not in fluid communication with one another. The channel may be part of a fluid flow path. The fluid flow path may include the channel, one or more inlet ports, one or more outlet ports, or any combination thereof. In an example, the fluid flow path may not include an outlet port. The inlet port, outlet port, or both may be in fluid communication with the channel. The inlet port may be configured to direct a solution comprising the sample to the channel. The chambers may be in fluid communication with the channel.

The channel may have a single inlet, multiple inlets, an outlet, multiple outlets, or any combination thereof. The inlet(s) may have the same diameter, or they may have different diameters. The inlet(s) may have diameters less than or equal to about 2.5 millimeters (mm), 2 mm, 1.5 mm, 1 mm, 0.5 mm, or less.

The device may comprise a long dimension and a short dimension. The long dimension may be less than or equal to about 20 centimeters (cm), 15 cm, 10 cm, 8 cm, 6 cm, 5 cm, 4 cm, 3 cm, 2 cm, 1 cm, or less. The short dimension of the device may be less than or equal to about 10 cm, 8 cm, 6 cm, 5 cm, 4 cm, 3 cm, 2 cm, 1 cm, 0.5 cm, or less. In an example, the dimensions of the device (e.g., microfluidic device) are about 7.5 cm by 2.5 cm. The channel may be substantially parallel to the long dimension of the microfluidic device. Alternatively, or in addition to, the channel may be substantially perpendicular to the long dimension of the microfluidic device (e.g., parallel to the short dimension of the device). Alternatively, or in addition to, the channel may be neither substantially parallel nor substantially perpendicular to the long dimension of the microfluidic device. The angle between the channel and the long dimension of the microfluidic device may be at least about 5°, 10°, 15°, 20°, 30°, 40°, 50°, 60°, 70°, or 90. In an example, the channel is a single long channel. Alternatively, or in addition to, the channel may have bends, curves, or angles. In an example, the channel may include a serpentine pattern that is configured to increase the length of the channel. The channel may have a long dimension that is less than or equal to about 100 millimeters (mm), 75 mm, 50 mm, 40 mm, 30 mm, 20 mm, 10 mm, 8 mm, 6 mm, 4 mm, 2 mm, or less. The length of the channel may be bounded by the external length or width of the microfluidic device. The channel may have a depth of less than or equal to about 500 micrometers (μm), 250 μm, 100 μm, 80 μm, 60 μm, 30 μm, 20 μm, 10 μm, or less. The channel may have a cross-sectional dimension (e.g., width or diameter) of less than or equal to about 500 μm, 250 μm, 100 μm, 75 μm, 50 μm, 40 μm, 30 μm, 20 μm, 10 μm, or less.

In some examples, the cross-sectional dimensions of the channel may be about 100 μm wide by about 100 μm deep. In some examples, the cross-sectional dimensions of the channel may be about 100 μm wide by about 80 μm deep. In some examples, the cross-sectional dimensions of the channel may be about 100 μm wide by about 60 μm deep. In some examples, the cross-sectional dimensions of the channel may be about 100 μm wide by about 40 μm deep. In some examples, the cross-sectional dimensions of the channel may be about 100 μm wide by about 20 μm deep. In some examples, the cross-sectional dimensions of the channel may be about 100 μm wide by about 10 μm deep. In some examples, the cross-sectional dimensions of the channel may be about 80 μm wide by about 100 μm deep. In some examples, the cross-sectional dimensions of the channel may be about 60 μm wide by about 100 μm deep. In some examples, the cross-sectional dimensions of the channel may be about 40 μm wide by about 100 μm deep. In some examples, the cross-sectional dimensions of the channel may be about 20 μm wide by about 100 μm deep. In some examples, the cross-sectional dimensions of the channel may be about 10 μm wide by about 100 μm deep. In some examples, the cross-sectional dimensions of the channel may be about 80 μm wide by about 80 μm deep. In some examples, the cross-sectional dimensions of the channel may be about 60 μm wide by about 60 μm deep. In some examples, the cross-sectional dimensions of the channel may be about 40 μm wide by about 40 μm deep. In some examples, the cross-sectional dimensions of the channel may be about 20 μm wide by about 20 μm deep. In some examples, the cross-sectional dimensions of the channel may be about 10 μm wide by about 10 μm deep.

### Method for Analyzing Analytes

In an aspect, the present disclosure provides a method for analyzing analytes or an analyte. The method may include providing a fluidic device (e.g., microfluidic device or device) that may be formed from a polymeric material (e.g., thermoplastic), and may include one or more of a first plurality of first chambers and a second plurality of second chambers. The first plurality of the first chambers may have a first chamber. The plurality of the second chambers may have a second chamber. The first chamber may have a first volume and the second chamber may have a second volume. The first volume may be different from the second volume. The fluidic device may not include any moving parts. The method may comprise directing a fluidic sample to the first chamber and second chamber. The fluidic sample may comprise the analytes or analyte. The method may comprise detecting the analyte in the first chamber, the second chamber, or both. In an example, the method the method includes directing a fluidic sample comprising an analyte to a first chamber and a second chamber of a fluidic device comprising a first plurality of chambers comprising at least about 100 first chambers and a second plurality of at least about 100 second chambers, wherein the first chamber has a first volume that is different from a second volume of a second chamber, and detecting the analyte in the first and second chambers.

Methods for analyzing analytes or an analyte may use any device, fluidic device, or microfluidic device as described elsewhere herein, including example devices shown in FIGS. 1A and 1B. The device may include a chamber, a plurality of chambers, and array of a plurality of chambers, or any combinations thereof. The device may include a single inlet port or multiple inlet ports. In an example, the device includes a single inlet port. In another example, the device includes two or more inlet ports. The device (i.e. fluidic device or microfluidic device) may be as described elsewhere herein.

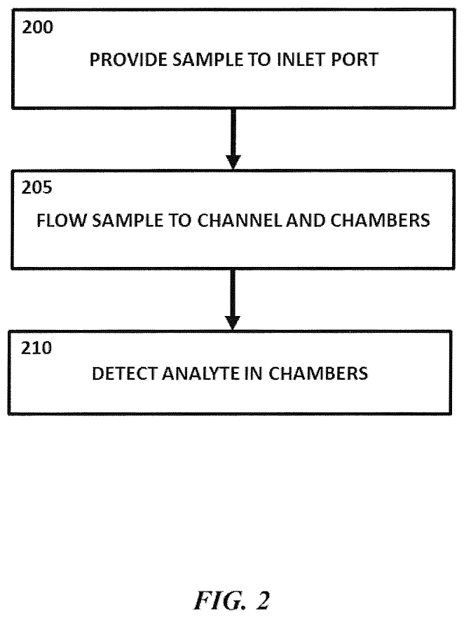

FIG. 2 schematically illustrates an example method for analyzing an analyte. A sample may be provided 200 at the inlet port(s) of a device of the method. The sample may be flowed 205 to a channel and the first and second plurality of chambers of the device and the analyte detected 210 in the first and second plurality of chambers.

The method may include devices wherein the volumes of the chambers provide different limits of detections of analytes. The first volume maybe larger, smaller, or the same volume of the second volume. The first volume may be at least twice, three times, five times, ten times, or one hundred times larger than the second volume. The method may include devices wherein the first volume provides a first lower limit of detection of an analyte in the first chamber that is lower than a second lower limit of detection of the analyte in the second chamber having the second volume. The first volume may provide a first upper limit of detection of an analyte in the first chamber that is lower than a second upper limit of detection of the analyte in the second chamber provided by the second volume of the second chamber. The method may include devices wherein the first volume provides a first lower limit of detection of an analyte in the first chamber that is higher than a second lower limit of detection of the analyte in the second chamber having the second volume. The first volume may provide a first upper limit of detection of an analyte in the first chamber that is higher than a second upper limit of detection of the analyte in the second chamber provided by the second volume of the second chamber. The method may include devices wherein the first volume provides a first lower limit of detection of an analyte in the first chamber that is the same as a second lower limit of detection of the analyte in the second chamber having the second volume. The first volume may provide a first upper limit of detection of an analyte in the first chamber that is the same as a second upper limit of detection of the analyte in the second chamber provided by the second volume of the second chamber. The limits of detection provided by volumes of chambers may be stable, variable, or customizable depending on the analyte, volumes of the chambers, or type of detection used.

The method may include detecting an analyte at a concentration at or above a first lower limit of detection and below a second lower limit of detection. The method may include detecting an analyte at a concentration above the first upper detection limit and below the second upper detection limit. An analyte may be detected at a concentration above the first and second lower limits of detection. An analyte may be detected at a concentration below the first and second upper limits of detection. An analyte may be detection at a concentration at a lower or upper limit of detection. A first lower limit and first upper limit of detection may provide a first working range of detection of an analyte. A second lower limit and second upper limit of detection may provide a second working range of detection of an analyte. The first and second working ranges of detecting an analyte may be different or the same. The first volume may provide a first working range of detecting analyte. The second volume may provide a second working range of detecting an analyte. The first working range may be greater or smaller than the second working range of detecting an analyte. The working ranges may be overlapping, or they may not overlap. The first and second working ranges may be of different relative sizes e.g. the first working range of detecting an analyte may have a higher upper limit of detection than the second working range of detecting an analyte, but the first working range of detecting an analyte may be smaller than the second working range of detecting an analyte. The first volume may permit analysis of a first analyte concentration range. The second volume may permit analysis of a second analyte concentration range. The first analyte concentration range may be different or the same as the second analyte concentration range. The first analyte concentration range may be larger or smaller than the second analyte concentration range.

The method may include applying a single or multiple pressure differentials to the inlet port to direct the solution from the inlet port to a channel. Alternatively, or in addition to, the device may include multiple inlet ports and the pressure differential may be applied to the multiple inlet ports. The inlet of the device (e.g., microfluidic device or fluidic device) may be in fluid communication with a fluid flow module, such as a pneumatic pump, vacuum source or compressor. The fluid flow module may provide positive or negative pressure to the inlet. The fluid flow module may apply a pressure differential to fill the device with a sample and partition (e.g., digitize) the sample into the chamber. Alternatively, or in addition to, the sample may be partitioned into a plurality of chambers as described elsewhere herein. Filling and partitioning of the sample may be performed without the use of valves between the chambers and the channel to isolate the sample. For example, filling of the channel may be performed by applying a pressure differential between the sample in the inlet port and the channel. This pressure differential may be achieved by pressurizing the sample or by applying vacuum to the channel and or chambers. Filling the chambers and partitioning the solution comprising the sample may be performed by applying a pressure differential between the channel and the chambers. This may be achieved by pressurizing the channel via the inlet port(s) or by applying a vacuum to the chambers. The solution comprising the sample may enter the chambers such that each chamber contains at least a portion of the solution.

In some cases, one single pressure differential may be used to deliver the solution with the sample (including molecule targets of interest) to the channel, and the same pressure differential may be used to continue to digitize (e.g., delivering the solution from the channel to the chamber) the chamber with the solution. Moreover, the single pressure differential may be sufficiently high to permit pressurized off-gassing or degassing of the channel or chamber. Alternatively, or in additional to, the pressure differential to deliver the solution with sample to the channel may be a first pressure differential. The pressure differential to deliver the solution from the channel to the chamber(s) may be a second pressure differential. The first and second pressure differentials may be the same or may be different. In an example, the second pressure differential is greater than the first pressure differential. Alternatively, the second pressure differential may be less than the first pressure differential. The first pressure differential, the second pressure differential, or both may be sufficiently high to permit pressurized off-gassing or degassing of the channel or chamber. In some cases, a third pressure differential may be used to permit pressurized off-gassing or degassing of the first channel, chambers, or both. Pressurized off-gassing or degassing of the first channel or chamber(s) may be permitted by the second channel or film or membrane. For example, when a pressure threshold is reached the film or membrane may permit gas to travel from the chamber, the first channel, or both the chamber and the first channel through the film or membrane to an environment outside of the chamber or first channel.

A different channel or film or membrane may employ different permeability characteristics under different applied pressure differentials. For example, the different channel or film or membrane may be gas impermeable at the first pressure differential (e.g., low pressure) and gas permeable at the second pressure differential (e.g., high pressure). The first and second pressure differentials may be the same or they may be different. During filling of the microfluidic device, the pressure of the inlet port may be higher than the pressure of the channel, permitting the solution in the inlet port to enter the channel. The first pressure differential (e.g., low pressure) may be less than or equal to about 8 psi, 6 psi, 4 psi, 2 psi, 1 psi, or less. In an example, the first pressure differential may be from about 1 psi to 8 psi. In another example, the first pressure differential may be from about 1 psi to 6 psi. In another example, the first pressure differential may be from about 1 psi to 4 psi. The chambers of the device may be filled by applying a second pressure differential between inlet and the chambers. The second pressure differential may direct fluid from the first channel into the chambers and gas from the first channel or chambers to an environment external to the first channel or chambers. The second pressure differential may be greater than or equal to about 1 psi, 2 psi, 4 psi, 6 psi, 8 psi, 10 psi, 12 psi 14 psi, 16 psi, 20 psi, or more. In an example, the second pressure differential is greater than about 4 psi. In another example, the second pressure differential is greater than about 8 psi. The and the microfluidic device may be filled and the sample partitioned by applying the first pressure differential, second pressure differential, or a combination thereof for less than or equal to about 20 minutes, 15 minutes, 10 minutes, 5 minutes, 3 minutes, 2 minutes, 1 minute, or less.

The sample may be partitioned by removing the excess sample from the channel by backfilling the channel with a gas or a fluid immiscible with an aqueous solution comprising the total second. The immiscible fluid may be provided after providing the solution comprising the sample such that the solution enters the channel first followed by the immiscible fluid. The immiscible fluid may be any fluid that does not mix with an aqueous fluid. The gas may be oxygen, nitrogen, carbon dioxide, air, a noble gas, or any combination thereof. The immiscible fluid may be an oil or an organic solvent. For example, the immiscible fluid may be silicone oil or other types of oil/organic solvent that have similar characteristics compared to the silicone oil. Alternatively, removing sample from the channel may prevent reagents in one chamber from diffusing through the siphon aperture into the channel and into other chambers. Sample within the channel may be removed by partitioning the sample into the chambers such that no sample remains in the channel or by removing excess sample form the first channel.

Directing the solution from the channel to the chamber or chambers may partition the sample. The device may permit partitioning of the sample into the chambers, or digitizing the samples, such that no residual solution remains in the channel or siphon apertures (e.g., such that there is no or substantially no sample dead volume). The solution comprising the sample may be partitioned such that there is zero or substantially zero sample dead volume (e.g., all sample and reagent input into the device are fluidically isolated within the chambers), which may prevent or reduce waste of sample and reagents. Alternatively, or in addition to, the sample may be partitioned by providing a sample volume that is less than a volume of the chamber(s). The volume of the first channel may be less than the total volume of the chambers such that all sample loaded into the first channel is distributed to the chambers. The total volume of the solution comprising the sample may be less than the total volume of the chambers. The volume of the solution may be 100%, 99%, 98%, 95%, 90%, 85%, 80%, or less than the total volume of the chambers. The solution may be added to the inlet port simultaneously with or prior to a gas or immiscible fluid being added to the inlet port. The volume of the gas or immiscible fluid may be greater than or equal to the volume of the first channel to fluidically isolate the chambers. A small amount of the gas or immiscible fluid may enter the siphon apertures or chambers.

Partitioning of the sample may be verified by the presence of an indicator within the reagent. An indicator may include a molecule comprising a detectable moiety. The detectable moiety may include radioactive species, fluorescent labels, chemiluminescent labels, enzymatic labels, colorimetric labels, or any combination thereof. Non-limiting examples of radioactive species include ³H, ¹⁴C, ²²Na, ³²P, ³³P, ³⁵S, ⁴²K, ⁴⁵Ca, ⁵⁹Fe, ¹²³I, ¹²⁴I, ¹²⁵I, ¹³¹I, or ²⁰³Hg. Non-limiting examples of fluorescent labels include fluorescent proteins, optically active dyes (e.g., a fluorescent dye), organometallic fluorophores, or any combination thereof. Non-limiting examples of chemiluminescent labels include enzymes of the luciferase class such as Cypridina, Gaussia, Renilla, and Firefly luciferases. Non-limiting examples of enzymatic labels include horseradish peroxidase (HRP), alkaline phosphatase (AP), beta galactosidase, glucose oxidase, or other types of labels.

The indicator molecule may be a fluorescent molecule. Fluorescent molecules may include fluorescent proteins, fluorescent dyes, and organometallic fluorophores. In some embodiments, the indicator molecule is a protein fluorophore. Protein fluorophores may include green fluorescent proteins (GFPs, fluorescent proteins that fluoresce in the green region of the spectrum, generally emitting light having a wavelength from 500-550 nanometers), cyan-fluorescent proteins (CFPs, fluorescent proteins that fluoresce in the cyan region of the spectrum, generally emitting light having a wavelength from 450-500 nanometers), red fluorescent proteins (RFPs, fluorescent proteins that fluoresce in the red region of the spectrum, generally emitting light having a wavelength from 600-650 nanometers). Non-limiting examples of protein fluorophores include mutants and spectral variants of AcGFP, AcGFP1, AmCyan, AmCyan1, AQ143, AsRed2, Azami Green, Azurite, BFP, Cerulean, CFP, CGFP, Citrine, copGFP, CyPet, dKeima-Tandem, DsRed, dsRed-Express, DsRed-Monomer, DsRed2, dTomato, dTomato-Tandem, EBFP, EBFP2, ECFP, EGFP, Emerald, EosFP, EYFP, GFP, HcRed-Tandem, HcRed1, JRed, Katuska, Kusabira Orange, Kusabira Orange2, mApple, mBanana, mCerulean, mCFP, mCherry, mCitrine, mECFP, mEmerald, mGrape1, mGrape2, mHoneydew, Midori-Ishi Cyan, mKeima, mKO, mOrange, mOrange2, mPlum, mRaspberry, mRFP1, mRuby, mStrawberry, mTagBFP, mTangerine, mTeal, mTomato, mTurquoise, mWasabi, PhiYFP, ReAsH, Sapphire, Superfolder GFP, T-Sapphire, TagCFP, TagGFP, TagRFP, TagRFP-T, TagYFP, tdTomato, Topaz, TurboGFP, Venus, YFP, YPet, ZsGreen, and ZsYellow1.

The indicator molecule may be a fluorescent dye. Non-limiting examples of fluorescent dyes include SYBR green, SYBR blue, DAPI, propidium iodine, Hoeste, SYBR gold, ethidium bromide, acridines, proflavine, acridine orange, acriflavine, fluorcoumanin, ellipticine, daunomycin, chloroquine, distamycin D, chromomycin, homidium, mithramycin, ruthenium polypyridyls, anthramycin, phenanthridines and acridines, ethidium bromide, propidium iodide, hexidium iodide, dihydroethidium, ethidium homodimer-1 and -2, ethidium monoazide, and ACMA, Hoechst 33258, Hoechst 33342, Hoechst 34580, DAPI, acridine orange, 7-AAD, actinomycin D, LDS751, hydroxystilbamidine, SYTOX Blue, SYTOX Green, SYTOX Orange, POPO-1, POPO-3, YOYO-1, YOYO-3, TOTO-1, TOTO-3, JOJO-1, LOLO-1, BOBO-1, BOBO-3, PO-PRO-1, PO-PRO-3, BO-PRO-1, BO-PRO-3, TO-PRO-1, TO-PRO-3, TO-PRO-5, JO-PRO-1, LO-PRO-1, YO-PRO-1, YO-PRO-3, PicoGreen, OliGreen, RiboGreen, SYBR Gold, SYBR Green I, SYBR Green II, SYBR DX, SYTO-40, -41, -42, -43, -44, -45 (blue), SYTO-13, -16, -24, -21, -23, -12, -11, -20, -22, -15, -14, -25 (green), SYTO-81, -80, -82, -83, -84, -85 (orange), SYTO-64, -17, -59, -61, -62, -60, -63 (red), fluorescein, fluorescein isothiocyanate (FITC), tetramethyl rhodamine isothiocyanate (TRITC), rhodamine, tetramethyl rhodamine, R-phycoerythrin, Cy-2, Cy-3, Cy-3.5, Cy-5, Cy5.5, Cy-7, Texas Red, Phar-Red, allophycocyanin (APC), Sybr Green I, Sybr Green II, Sybr Gold, CellTracker Green, 7-AAD, ethidium homodimer I, ethidium homodimer II, ethidium homodimer III, ethidium bromide, umbelliferone, eosin, green fluorescent protein, erythrosin, coumarin, methyl coumarin, pyrene, malachite green, stilbene, lucifer yellow, cascade blue, dichlorotriazinylamine fluorescein, dansyl chloride, fluorescent lanthanide complexes such as those including europium and terbium, carboxy tetrachloro fluorescein, 5 or 6-carboxy fluorescein (FAM), 5- (or 6-) iodoacetamidofluorescein, 5-{[2(and 3)-5-(Acetylmercapto)-succinyl]amino}fluorescein (SAMSA-fluorescein), lissamine rhodamine B sulfonyl chloride, 5 or 6 carboxy rhodamine (ROX), 7-amino-methyl-coumarin, 7-Amino-4-methylcoumarin-3-acetic acid (AMCA), BODIPY fluorophores, 8-methoxypyrene-1,3,6-trisulfonic acid trisodium salt, 3,6-Disulfonate-4-amino-naphthalimide, phycobiliproteins, AlexaFluor 350, 405, 430, 488, 532, 546, 555, 568, 594, 610, 633, 635, 647, 660, 680, 700, 750, and 790 dyes, DyLight 350, 405, 488, 550, 594, 633, 650, 680, 755, and 800 dyes, or other fluorophores.

The indicator molecule may be an organometallic fluorophore. Non limiting examples of organometallic fluorophores include lanthanide ion chelates, nonlimiting examples of which include tris (dibenzoylmethane) mono(1,10-phenanthroline) europium (111), tris (dibenzoylmethane) mono(5-amino-1,10-phenanthroline) europium (111), and Lumi4-Tb cryptate.

The method may further include detecting one or more components of the solution, one or more components of the sample, or a reaction with one or more components of the sample. The components or component may be analytes or an analyte. Detecting the one or more analytes, one or more components of the solution, one or more components of the sample or the reaction may include imaging the chamber. The images may be taken of the microfluidic device. Images may be taken of single chambers, an array of chambers, a plurality of chambers, or of multiple arrays or pluralities of chambers concurrently. The images may be taken through the body of the microfluidic device. The images may be taken through the film or membrane of the microfluidic device. In an example, the images are taken through both the body of the microfluidic device and through the thin film. The body of the microfluidic device may be substantially optically transparent. Alternatively, the body of the microfluidic device may substantially optically opaque. In an example, the film or membrane may be substantially optically transparent. The images may be taken prior to filling the microfluidic device with sample. The Images may be taken after filling of the microfluidic device with sample. The images may be taken during filling the microfluidic device with sample. The images may be taken to verify partitioning of the sample. The images may be taken during a reaction to monitor products of the reaction. In an example, the products of the reaction comprise amplification products. The images may be taken at specified intervals. Alternatively, or in addition to, a video may be taken of the microfluidic device. The specified intervals may include taking an image at least about every 300 seconds, 240 seconds, 180 seconds, 120 seconds, 90 seconds, 60 seconds, 30 seconds, 15 seconds, 10 seconds, 5 seconds, 4 seconds, 3 seconds, 2 seconds, 1 second, or more frequently during a reaction.

The sample may be any biological or chemical analyte such as, but not limited to, a nucleic acid molecule, protein, enzyme, antibody, or other biological molecule. In an example, the sample includes one or more nucleic acid molecules. Processing the nucleic acid molecules may further include thermal cycling the chamber or chambers to amplify the nucleic acid molecules. The method may further include controlling a temperature of the channel or the chamber(s). The method for using a microfluidic device may further comprise amplification of a nucleic acid sample. The microfluidic device may be filled with an amplification reagent comprising nucleic acid molecules, components used for an amplification reaction, an indicator molecule, and an amplification probe. The amplification may be performed by thermal cycling the plurality of chambers. Detection of nucleic acid amplification may be performed by imaging the chambers of the microfluidic device. The nucleic acid molecules may be quantified by counting the chambers in which the nucleic acid molecules are successfully amplified and applying Poisson statistics. In some embodiments, nucleic acid amplification and quantification may be performed in a single integrated unit.

A variety of nucleic acid amplification reactions may be used to amplify the nucleic acid molecule in a sample to generate an amplified product. Amplification of a nucleic acid target may be linear, exponential, or a combination thereof. Non-limiting examples of nucleic acid amplification methods include primer extension, polymerase chain reaction, reverse transcription, isothermal amplification, ligase chain reaction, helicase-dependent amplification, asymmetric amplification, rolling circle amplification, and multiple displacement amplification. In some embodiments, the amplification product is DNA or RNA. For embodiments directed towards DNA amplification, any DNA amplification method may be employed. DNA amplification methods include, but are not limited to, PCR, real-time PCR, assembly PCR, asymmetric PCR, digital PCR, dial-out PCR, helicase-dependent PCR, nested PCR, hot start PCR, inverse PCR, methylation-specific PCR, miniprimer PCR, multiplex PCR, overlap-extension PCR, thermal asymmetric interlaced PCR, touchdown PCR, and ligase chain reaction. In some embodiments, DNA amplification is linear, exponential, or any combination thereof. In some embodiments, DNA amplification is achieved with digital PCR (dPCR).

Reagents used for nucleic acid amplification may include polymerizing enzymes, reverse primers, forward primers, and amplification probes. Examples of polymerizing enzymes include, without limitation, nucleic acid polymerase, transcriptase, or ligase (e.g., enzymes which catalyze the formation of a bond). The polymerizing enzyme can be naturally occurring or synthesized. Examples of polymerases include a DNA polymerase, and RNA polymerase, a thermostable polymerase, a wild-type polymerase, a modified polymerase, E. coli DNA polymerase I, T7 DNA polymerase, bacteriophage T4 DNA polymerase 129 (phi29) DNA polymerase, Taq polymerase, Tth polymerase, Tli polymerase, Pfu polymerase Pwo polymerase, VENT polymerase, DEEPVENT polymerase, Ex-Taq polymerase, LA-Taw polymerase, Sso polymerase Poc polymerase, Pab polymerase, Mth polymerase ES4 polymerase, Tru polymerase, Tac polymerase, Tne polymerase, Tma polymerase, Tca polymerase, Tih polymerase, Tfi polymerase, Platinum Taq polymerases, Tbr polymerase, Tfl polymerase, Pfutubo polymerase, Pyrobest polymerase, KOD polymerase, Bst polymerase, Sac polymerase, Klenow fragment polymerase with 3′ to 5′ exonuclease activity, and variants, modified products and derivatives thereof. For a Hot Start polymerase, a denaturation cycle at a temperature from about 92° C. to 95° C. for a time period from about 2 minutes to 10 minutes may be used.

The amplification probe may be a sequence-specific oligonucleotide probe. The amplification probe may be optically active when hybridized with an amplification product. In some embodiments, the amplification probe is or becomes detectable as nucleic acid amplification progresses. The intensity of the optical signal may be proportional to the amount of amplified product. A probe may be linked to any of the optically active detectable moieties (e.g., dyes) described herein and may also include a quencher capable of blocking the optical activity of an associated dye. Non-limiting examples of probes that may be useful as detectable moieties include TaqMan probes, TaqMan Tamara probes, TaqMan MGB probes, Lion probes, locked nucleic acid probes, or molecular beacons. Non-limiting examples of quenchers that may be useful in blocking the optical activity of the probe include Black Hole Quenchers (BHQ), Iowa Black FQ and RQ quenchers, or Internal ZEN Quenchers. Alternatively, or in addition to, the probe or quencher may be any probe that is useful in the context of the methods of the present disclosure.

The amplification probe is a dual labeled fluorescent probe. The dual labeled probe may include a fluorescent reporter and a fluorescent quencher linked with a nucleic acid. The fluorescent reporter and fluorescent quencher may be positioned in close proximity to each other. The close proximity of the fluorescent reporter and fluorescent quencher may block the optical activity of the fluorescent reporter. The dual labeled probe may bind to the nucleic acid molecule to be amplified. During amplification, the fluorescent reporter and fluorescent quencher may be cleaved by the exonuclease activity of the polymerase. Cleaving the fluorescent reporter and quencher from the amplification probe may cause the fluorescent reporter to regain its optical activity and enable detection. The dual labeled fluorescent probe may include a 5′ fluorescent reporter with an excitation wavelength maximum of at least about 450 nanometers (nm), 500 nm, 525 nm, 550 nm, 575 nm, 600 nm, 625 nm, 650 nm, 675 nm, 700 nm, or higher and an emission wavelength maximum of about 500 nm, 525 nm, 550 nm, 575 nm, 600 nm, 625 nm, 650 nm, 675 nm, 700 nm, or higher. The dual labeled fluorescent probe may also include a 3′ fluorescent quencher. The fluorescent quencher may quench fluorescent emission wavelengths between about 380 nm and 550 nm, 390 nm and 625 nm, 470 nm and 560 nm, 480 nm and 580 nm, 550 nm and 650 nm, 550 nm and 750 nm, or 620 nm and 730 nm.

The nucleic acid amplification may be performed by thermal cycling the chambers of the microfluidic device. Thermal cycling may include controlling the temperature of the microfluidic device by applying heating or cooling to the microfluidic device. Heating or cooling methods may include resistive heating or cooling, radiative heating or cooling, conductive heating or cooling, convective heating or cooling, or any combination thereof. Thermal cycling may include cycles of incubating the chambers at a temperature sufficiently high to denature nucleic acid molecules for a duration followed by incubation of the chambers at an extension temperature for an extension duration. Denaturation temperatures may vary depending upon, for example, the particular nucleic acid sample, the reagents used, and the reaction conditions. A denaturation temperature may be from about 80° C. to 110° C. 85° C. to about 105° C., 90° C. to about 100° C., 90° C. to about 98° C., 92° C. to about 95° C. The denaturation temperature may be at least about 80° C., 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C., 100° C., or higher.

The duration for denaturation may vary depending upon, for example, the particular nucleic acid sample, the reagents used, and the reaction conditions. The duration for denaturation may be less than or equal to about 300 seconds, 240 seconds, 180 seconds, 120 seconds, 90 seconds, 60 seconds, 55 seconds, 50 seconds, 45 seconds, 40 seconds, 35 seconds, 30 seconds, 25 seconds, 20 seconds, 15 seconds, 10 seconds, 5 seconds, 2 seconds, or 1 second.

Extension temperatures may vary depending upon, for example, the particular nucleic acid sample, the reagents used, and the reaction conditions. An extension temperature may be from about 30° C. to 80° C., 35° C. to 75° C., 45° C. to 65° C., 55° C. to 65° C., or 40° C. to 60° C. An extension temperature may be at least about 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., or 80° C.

Extension time may vary depending upon, for example, the particular nucleic acid sample, the reagents used, and the reaction conditions. In some embodiments, the duration for extension may be less than or equal to about 300 seconds, 240 seconds, 180 seconds, 120 seconds, 90 seconds, 60 seconds, 55 seconds, 50 seconds, 45 seconds, 40 seconds, 35 seconds, 30 seconds, 25 seconds, 20 seconds, 15 seconds, 10 seconds, 5 seconds, 2 seconds, or 1 second. In an alternative embodiment, the duration for extension may be no more than about 120 seconds, 90 seconds, 60 seconds, 55 seconds, 50 seconds, 45 seconds, 40 seconds, 35 seconds, 30 seconds, 25 seconds, 20 seconds, 15 seconds, 10 seconds, 5 seconds, 2 seconds, or 1 second. In an example, the duration for the extension reaction is less than or equal to about 10 seconds.

Nucleic acid amplification may include multiple cycles of thermal cycling. Any suitable number of cycles may be performed. The number of cycles performed may be more than about 5, 10, 15, 20, 30, 40, 50, 60, 70, 80, 90, 100 cycles, or more. The number of cycles performed may depend upon the number of cycles to obtain detectable amplification products. For example, the number of cycles to detect nucleic acid amplification during dPCR may be less than or equal to about 100, 90, 80, 70, 60, 50, 40, 30, 20, 15, 10, 5 cycles, or less. In an example, less than or equal to about 40 cycles are used and the cycle time is less than or equal to about 20 minutes.

The time to reach a detectable amount of amplification product may vary depending upon the particular nucleic acid sample, the reagents used, the amplification reaction used, the number of amplification cycles used, and the reaction conditions. In some embodiments, the time to reach a detectable amount of amplification product may be about 120 minutes or less, 90 minutes or less, 60 minutes or less, 50 minutes or less, 40 minutes or less, 30 minutes or less, 20 minutes or less, 10 minutes or less, or 5 minutes or less. In an example, a detectable amount of amplification product may be reached in less than 20 minutes.

### Systems for Processing or Analyzing Samples

In an aspect, the present disclosure may provide systems for processing a sample. The system may include a device (e.g., microfluidic device), a holder, and a fluid flow channel. The system may be used with any device or may implement any method described elsewhere herein. The holder may be configured to receive and retain the device during processing. The fluid flow module may be configured to fluidically couple to the inlet port and supply a pressure differential to subject the solution to flow from the inlet port to the channel. Additionally, the fluid flow module may be configured to supply a pressure differential to subject at least a portion of the solution to flow from the first channel to the chamber.

The holder may be a shelf, receptacle, or stage for holding the device. In an example, the holder is a transfer stage. The transfer stage may be configured input the microfluidic device, hold the microfluidic device, and output the microfluidic device. The microfluidic device may be any device described elsewhere herein. The transfer stage may be stationary in one or more coordinates. Alternatively, or in addition to, the transfer stage may be capable of moving in the X-direction, Y-direction, Z-direction, or any combination thereof. The transfer stage may be capable of holding a single microfluidic device. Alternatively, or in addition to, the transfer stage may be capable of holding at least 2, 3, 4, 5, 6, 7, 8, 9, 10, or more microfluidic devices.

The fluid flow module may be a pneumatic module, a vacuum module, or both. The fluid flow module may be configured to be in fluid communication with the inlet port(s) of the microfluidic device. The fluid flow module may have multiple connection points capable of connecting to multiple inlet port(s). The fluid flow module may be able to fill, backfill, and partition a single array of chambers at a time or multiple arrays of chambers in tandem. The fluid flow module may be a pneumatic module combined with a vacuum module. The fluid flow module may provide increased pressure to the microfluidic device or provide vacuum to the microfluidic device.

The system may further comprise a thermal module. The thermal module may be configured to be in thermal communication with the chambers of the microfluidic devices. The thermal module may be configured to control the temperature of a single array of chambers or to control the temperature of multiple arrays of chambers. Each array of chambers may be individually addressable by the thermal module. For example, thermal module may perform the same thermal program across all arrays of chambers or may perform different thermal programs with different arrays of chambers. The thermal module may be in thermal communication with the microfluidic device or the chambers of the microfluidic device. The thermal module may heat or cool the microfluidic device. One or more surfaces of the microfluidic device may be in direct contact with the thermal module. Alternately, or in addition to, a thermally conductive material may be disposed between the thermal module and the microfluidic device. The thermal module may maintain the temperature across a surface of the microfluidic device such that the variation is less than or equal to about 2° C., 1.5° C., 1° C., 0.9° C., 0.8° C., 0.7° C., 0.6° C., 0.5° C., 0.4° C., 0.3° C., 0.2° C., 0.1° C., or less. The thermal module may maintain a temperature of a surface of the microfluidic device that is within about plus or minus 0.5° C., 0.4° C., 0.3° C., 0.2° C., 0.1° C., 0.05° C., or closer to a temperature set point.

The system may further include a detection module. The detection module may provide electronic or optical detection. In an example, the detection module is an optical module providing optical detection. The optical module may be configured to emit and detect multiple wavelengths of light. Emission wavelengths may correspond to the excitation wavelengths of the indicator and amplification probes used. The emitted light may include wavelengths with a maximum intensity around about 450 nm, 500 nm, 525 nm, 550 nm, 575 nm, 600 nm, 625 nm, 650 nm, 675 nm, 700 nm, or any combination thereof. Detected light may include wavelengths with a maximum intensity around about 500 nm, 525 nm, 550 nm, 575 nm, 600 nm, 625 nm, 650 nm, 675 nm, 700 nm, or any combination thereof. The optical module may be configured to emit more than one, two, three, four, or more wavelengths of light. The optical module may be configured to detect more than one, two, three, four, or more wavelengths of light. One emitted wavelength of light may correspond to the excitation wavelength of an indicator molecule. Another emitted wavelength of light may correspond to the excitation wavelength of an amplification probe. One detected wavelength of light may correspond to the emission wavelength of an indicator molecule. Another detected wavelength of light may correspond to an amplification probe used to detect a reaction within the chambers. The optical module may be configured to image sections of an array of chambers. Alternatively, or in addition to, the optical module may image an entire array of chambers in a single image. In an example, the optical module is configured to take video of the device.

The system may further include a robotic arm. The robotic arm may move, alter, or arrange a position of the microfluidic device. Alternatively, or in addition to, the robotic arm may arrange or move other components of the system (e.g., fluid flow module or detection module). The detection module may include a camera (e.g., a complementary metal oxide semiconductor (CMOS) camera) and filter cubes. The filter cubes may alter or modify the wavelength of excitation light or the wavelength of light detected by the camera. The fluid flow module may comprise a manifold (e.g., pneumatic manifold) or one or more pumps. The manifold may be in an upright position such that the manifold does not contact the microfluidic device. The upright position may be used when loading or imaging the microfluidic device. The manifold may be in a downward position such that the manifold contacts the microfluidic device. The manifold may be used to load fluids (e.g., samples and reagents) into the microfluidic device. The manifold may apply a pressure to the microfluidic device to hold the device in place or to prevent warping, bending, or other stresses during use. In an example, the manifold applies a downward pressure and holds the microfluidic device against the thermal module.

The system may further include one or more computer processors. The one or more computer processors may be operatively coupled to the fluid flow module, holder, thermal module, detection module, robotic arm, or any combination thereof. In an example, the one or more computer processors is operatively coupled to the fluid flow module. The one or more computer processors may be individually or collectively programmed to direct the fluid flow module to supply a pressure differential to the inlet port when the fluid flow module is fluidically coupled to the inlet port to subject the solution to flow from the inlet port to the channel or from the channel to the chamber(s) and, thereby, partition through pressurized out-gassing of the chambers.

For example, while described in the context of a dPCR application, other microfluidic devices which may require a number of isolated chambers filled with a liquid, that are isolated via a gas or other fluid, may benefit from the use of a thin thermoplastic film to allow outgassing to avoid gas fouling while also providing an advantage with respect to manufacturability and cost. Other than PCR, other nucleic acid amplification methods such as loop mediated isothermal amplification can be adapted to perform digital detection of specific nucleic acid sequences according to embodiments of the present disclosure. The chambers can also be used to isolate single cells with the siphoning apertures designed to be close to the diameter of the cells to be isolated. In some embodiments, when the siphoning apertures are much smaller than the size of blood cells, embodiments of the present disclosure can be used to separate blood plasma from whole blood.

### Computer Systems

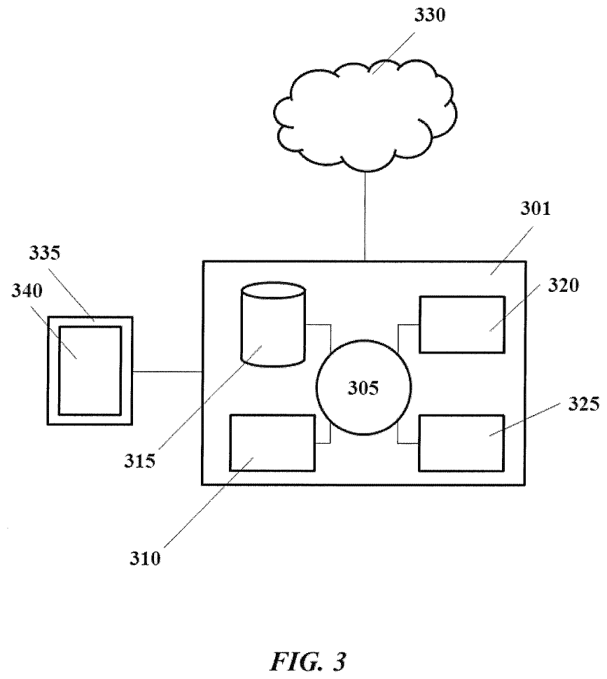

The present disclosure provides computer systems that are programmed to implement methods of the disclosure. FIG. 3 shows a computer system 301 that is programmed or otherwise configured to analyze analytes. The computer system 301 can regulate various aspects of sample loading, fluid control, robotic or liquid handling control, flow control, mechanical parts control, data collection, image collection, and analysis of the present disclosure, such as, for example, controlling the fluidics of a device, interfacing with an electric or optical detection module to set wavelength detection, detection area, and sensitivity, storing data collected from the detector module, or controlling PCR settings. The computer system 301 can be an electronic device of a user or a computer system that is remotely located with respect to the electronic device. The electronic device can be a mobile electronic device.

The computer system 301 includes a central processing unit (CPU, also “processor” and “computer processor” herein) 305, which can be a single core or multi core processor, or a plurality of processors for parallel processing. The computer system 301 also includes memory or memory location 310 (e.g., random-access memory, read-only memory, flash memory), electronic storage unit 315 (e.g., hard disk), communication interface 320 (e.g., network adapter) for communicating with one or more other systems, and peripheral devices 325, such as cache, other memory, data storage, electronic display adapters, or any combination thereof. The memory 310, storage unit 315, interface 320 and peripheral devices 325 are in communication with the CPU 305 through a communication bus (solid lines), such as a motherboard. The storage unit 315 can be a data storage unit (or data repository) for storing data. The computer system 301 can be operatively coupled to a computer network (“network”) 330 with the aid of the communication interface 320. The network 330 can be the Internet, an internet, extranet, an intranet or extranet that is in communication with the Internet, or any combination thereof. The network 330 in some cases is a telecommunication, data network, or any combination thereof. The network 330 can include one or more computer servers, which can enable distributed computing, such as cloud computing. The network 330, in some cases with the aid of the computer system 301, can implement a peer-to-peer network, which may enable devices coupled to the computer system 301 to behave as a client or a server.

The CPU 305 can execute a sequence of machine-readable instructions, which can be embodied in a program or software. The instructions may be stored in a memory location, such as the memory 310. The instructions can be directed to the CPU 305, which can subsequently program or otherwise configure the CPU 305 to implement methods of the present disclosure. Examples of operations performed by the CPU 305 can include fetch, decode, execute, and writeback.

The CPU 305 can be part of a circuit, such as an integrated circuit. One or more other components of the system 301 can be included in the circuit. In some cases, the circuit is an application specific integrated circuit (ASIC).

The storage unit 315 can store files, such as drivers, libraries and saved programs. The storage unit 315 can store user data, e.g., user preferences and user programs. The computer system 301 in some cases can include one or more additional data storage units that are external to the computer system 301, such as located on a remote server that is in communication with the computer system 301 through an intranet or the Internet.

The computer system 301 can communicate with one or more remote computer systems through the network 330. For instance, the computer system 301 can communicate with a remote computer system of a user (e.g., technician). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 301 via the network 330.

Methods as described herein can be implemented by way of machine (e.g., computer processor) executable code stored on an electronic storage location of the computer system 301, such as, for example, on the memory 310 or electronic storage unit 315. The machine executable or machine-readable code can be provided in the form of software. During use, the code can be executed by the processor 305. In some cases, the code can be retrieved from the storage unit 315 and stored on the memory 310 for ready access by the processor 305. In some situations, the electronic storage unit 315 can be precluded, and machine-executable instructions are stored on memory 310.

The code can be pre-compiled and configured for use with a machine having a processer adapted to execute the code or can be compiled during runtime. The code can be supplied in a programming language that can be selected to enable the code to execute in a pre-compiled or as-compiled fashion.

Aspects of the systems and methods provided herein, such as the computer system 301, can be embodied in programming. Various aspects of the technology may be thought of as “products” or “articles of manufacture” typically in the form of machine (or processor) executable code, associated data that is carried on or embodied in a type of machine readable medium, or any combination thereof. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code, data, or any combination thereof. Many of these forms of computer readable media may be involved in carrying one or more sequences of one or more instructions to a processor for execution.

The computer system 301 can include or be in communication with an electronic display 335 that comprises a user interface (UI) 340 for providing, for example, detection parameters, fluidic settings, PCR conditions and temperatures, etc. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 305. The algorithm can, for example, optimize detection settings, set fluid flow parameters, control fluidics, optimize PCR conditions and temperatures, alert a user of errors, etc.

While some embodiments of the present devices and methods have been shown and described herein, it will be obvious to those skilled in the art that such embodiments are provided by way of example only. It is not intended that the devices and methods be limited by the specific examples provided within the specification. While the devices and methods has been described with reference to the aforementioned specification, the descriptions and illustrations of the embodiments herein are not meant to be construed in a limiting sense. Numerous variations, changes, and substitutions will now occur to those skilled in the art without departing from the devices and methods. Furthermore, it shall be understood that all aspects of the devices and methods are not limited to the specific depictions, configurations or relative proportions set forth herein which depend upon a variety of conditions and variables. It will be understood that various alternatives to the embodiments of the devices and methods described herein may be employed in practicing the devices and methods. It is therefore contemplated that the devices and methods shall also cover any such alternatives, modifications, variations or equivalents. It is intended that the following claims define the scope of the devices and methods and that methods and structures within the scope of these claims and their equivalents be covered thereby.

What is claimed is:

1. A device for partitioning a sample, comprising:
a first plurality of chambers and a second plurality of chambers, wherein:
(i) said first plurality of chambers comprises at least about 100 first chambers;
(ii) said second plurality of chambers comprises at least about 100 second chambers; and
(iii) a first chamber of said at least about 100 first chambers has a first volume different from a second volume of a second chamber of said at least about 100 second chambers.

2. The device of claim 1, wherein said first volume is at least twice as large as said second volume.

3. The device of claim 2, wherein said first volume is at least five times as large as said second volume.

4. The device of claim 2, wherein said device does not include any moving parts.

5. The device of claim 1, further comprising a channel in fluid communication with said first plurality of chambers and said second plurality of chambers.

6. The device of claim 5, further comprising a cover configured to seal said first plurality of chambers, said second plurality of chambers, and said channel.

7. The device of claim 6, further comprising a body comprising said channel, said first plurality of chambers, and said second plurality of chambers, and wherein said cover is fixed to said body.

8. The device of claim 5, wherein said second plurality of chambers is in fluid communication with said channel upstream of said first plurality of chambers.

9. The device of claim 5, wherein said channel comprises at least two branches, and wherein said first plurality of chambers is disposed along a first branch of said at least two branches and said second plurality of chambers is disposed along a second branch of said at least two branches.

10. The device of claim 1, wherein said first plurality of chambers comprises at least about 1,000 first chambers and wherein said second plurality of chamber comprises at least about 1,000 second chambers.

11. The device of claim 10, wherein said first plurality of chambers comprises at least about 5,000 first chambers and wherein said second plurality of chamber comprises at least about 5,000 second chambers.

12. The device of claim 1, wherein a total volume of said first plurality of chambers is less than about 10 microliters (μL).

13. The device of claim 1, wherein a total first volume of said first plurality of chambers is greater than or equal to about 10 μL.

14. The device of claim 1, wherein a total second volume of said second plurality of chambers is less than about 1 μL.

15. The device of claim 1, wherein a total volume of said second plurality of chambers is greater than or equal to about 1 μL.

16. The device of claim 1, wherein a total first volume of said first plurality of chambers is at least five times as large as a total second volume of said second plurality of chambers.

17. The device of claim 16, wherein said total first volume is at least ten times as large as said total second volume.

18. The device of claim 1, wherein first chambers of said first plurality of chambers comprise substantially similar volumes.

19. The device of claim 1, wherein second chambers of said second plurality of chambers comprise substantially similar volumes.

20. The device of claim 1, wherein said first volume is greater than or equal to about 100 picoliters (pL).

21. The device of claim 20, wherein said first volume is less than or equal to about 1000 pL.

22. The device of claim 1, wherein said second volume is less than or equal to about 250 pL.

23. The device of claim 22, wherein said second volume is greater than or equal to about 25 pL.

24. The device of claim 1, wherein a first depth of said first chamber is substantially similar to a second depth of said second chamber.

25. The device of claim 24, wherein a first cross-sectional area of said first chamber is substantially different than a second cross-sectional area of said second chamber.

26. The device of claim 1, wherein said device is a microfluidic device.

27. A method of analyzing an analyte, comprising:
(i) providing a fluidic device comprising a plurality of first chambers and a plurality of second chambers, wherein;
(a) said first plurality of chambers comprises at least about 100 first chambers;
(b) said second plurality of chambers comprises at least about 100 second chambers; and
(c) a first chamber of said at least about 100 first chambers has a first volume different from a second volume of a second chamber of said at least about 100 second chambers
(ii) directing a fluidic sample comprising said analyte to said first chamber and said second chamber; and
(iii) detecting said analyte in said first chamber and said second chamber.

28. The method of claim 27, wherein said first volume provides a first lower limit of detection of said analyte in said first chamber that is lower than a second lower limit of detection of said analyte in said second chamber provided by said second volume.

29. The method of claim 28, wherein said first volume provides a first upper limit of detection of said analyte in said first chamber that is lower than a second upper limit of detection of said analyte in said second chamber provided by said second volume of said second chamber.

30. The method of claim 28, further comprising detecting said analyte at a concentration at or above said first lower limit of detection and below said second lower limit of detection.

31. The method of claim 30, further comprising detecting said analyte at a concentration above said first upper detection limit and below said second upper detection limit.

32. The method of claim 27, wherein said first volume provides a first working range of detection of said analyte in said first chamber that is different than a second working range of detection of said analyte in said second chamber provided by said second volume.

33. The method of claim 27, wherein said first volume permits analysis of a first analyte concentration and said second volume permits analysis of a second analyte concentration, and wherein said first analyte concentration and said second analyte concentration are different.

34. The method of claim 27, wherein said first volume is at least twice as large as said second volume.

35. The method of claim 34, wherein said first volume is at least five times as large as said second volume.

36. The method of claim 27, wherein said fluidic device does not include any moving parts.

37. The method of claim 27, wherein said fluidic device further comprises a channel in fluid communication with said first plurality of chambers and said second plurality of chambers, and wherein, in (ii), said fluidic sample is directed from said channel to said first chamber and said second chamber.

38. The method of claim 37, further comprising a cover configured to seal said first plurality of chambers, said second plurality of chambers, and said channel.

39. The method of claim 38, wherein said fluidic device comprises a body comprising said channel, said first plurality of chambers, and said second plurality of chambers, and wherein said cover is fixed to said body.

40. The method of claim 37, wherein said second plurality of chambers are in fluid communication with said channel upstream of said first plurality of chambers.

41. The method of claim 37, wherein said channel comprises at least two branches, and wherein said first plurality of chambers is disposed along a first branch of said at least two branches and said second plurality of chambers is disposed along a second branch of said at least two branches.

42. The method of claim 27, wherein said first plurality of chambers comprises at least about 1,000 first chambers and said second plurality of chamber comprises at least about 1,000 second chambers.

43. The method of claim 42, wherein said first plurality of chambers comprises at least about 5,000 first chambers and said second plurality of chamber comprises at least about 5,000 second chambers.

44. The method of claim 27, wherein a total volume of said first plurality of chambers is less than about 10 microliters (μL).

45. The method of claim 27, wherein a total volume of said first plurality of chambers is greater than or equal to about 10 μL.

46. The method of claim 27, wherein a total volume of said second plurality of chambers is less than about 1 μL.

47. The method of claim 27, wherein a total volume of said second plurality of chambers is greater than or equal to about 1 μL.

48. The method of claim 27, wherein a total first volume of said first plurality of chambers is at least five times as large as a total second volume of said second plurality of chambers.

49. The method of claim 48, wherein said total first volume is at least ten times as large as said total second volume.

50. The method of claim 27, wherein first chambers of said first plurality of chambers comprise substantially similar volumes.

51. The method of claim 27, wherein second chambers of said second plurality of chambers comprise substantially similar volumes.

52. The method of claim 27, wherein said first volume is greater than or equal to about 100 picoliters (pL).

53. The method of claim 52, wherein said first volume is less than or equal to about 1000 pL.

54. The method of claim 27, wherein said second volume is less than or equal to about 250 pL.

55. The method of claim 54, wherein said second volume is greater than or equal to about 25 pL.

56. The method of claim 27, wherein a depth of said first chamber is substantially similar to a depth of said second chamber.

57. The method of claim 56, wherein a cross-sectional area of said first chamber is substantially different than a cross-sectional area of said second chamber.
